(19) United States
(12) Patent Application Publication
(10) Pub. No.: US 2026/0163447 A1
(43) Pub. Date: Jun. 11, 2026

(54) BRUSHLESS DC MOTOR

(71) Applicant: BELIMO HOLDING AG, Hinwil (CH)

(72) Inventor: Stefan WILDHABER, Neuhaus (CH)

(73) Assignee: BELIMO HOLDING AG, Hinwil (CH)

(21) Appl. No.: 18/706,527

(22) PCT Filed: Nov. 3, 2022
(86) PCT No.: PCT/EP2022/080650

§ 371 Date: May 1, 2024

(30) Foreign Application Priority Data
Nov. 11, 2021 (CH) CH070543/2021

(51) Int. Cl. H02K 7/09; F16C 33/20; H02K 7/116

(52) U.S. Cl. CPC H02K 7/09; F16C 33/20; H02K 7/116; F16C 2380/26

(57) ABSTRACT

A brushless DC motor includes a stator, a permanent magnet rotor, a motor shaft, and a shaft bearing. The brushless DC motor has a motor axis. The stator includes a set of teeth, each of the teeth being spaced apart from the rotor by a gap having a gap width. The motor shaft and the shaft bearing are radially biased with respect to each other by a magnetic biasing force, the magnetic biasing force acting in a fixed radial direction. A tooth design of the teeth differs among the teeth.

### FIELD OF THE INVENTION

The present invention relates to electric motors, in particular brushless DC motors and devices that use such motors, for example servo drives. The invention is particularly useful in cost-sensitive applications where the motor must nevertheless operate in a wide temperature range.

### BACKGROUND OF THE INVENTION

Brushless DC motors (BLDC motors or BL motors), also known as an electronically commutated motors (ECM or EC motors) or synchronous DC motors) show a number of advantages over conventional DC motors and are used in a wide variety of applications, for example as fan motors, hard disk drives or servo drives.

Some applications, for example servo drives for operating valves and/or dampers in HVAC (Heating, ventilation, and air conditioning) applications require a comparatively larger operation temperature range of, e.g. −30° C. to +70° C.

### SUMMARY OF THE INVENTION

Spanning such a large temperature range requires a particularly careful design and material selection that considers, among others, the thermal expansion coefficients. In this context, in particular the motor shaft and the shaft bearing are critical. According to the state of the art, the motor shaft is made from steel and the shaft bearing is either a ball bearing or a sintered bearing. Since the thermal expansion coefficient is in these cases similar to steel, the requirements regarding the temperature range can be met, while keeping the tolerances respectively the play between shaft and shaft bearing low. Such bearings, however, are relatively expensive.

Therefore, it is generally desirable to use shaft bearings made from plastics instead. Such plastic bearings (optionally formed integrally with a pinion), however, generally have a large thermal expansion coefficient. In order to prevent jamming at the lowest operational temperature of, e.g. −30° C., the diameter of the bore for the motor shaft must be relatively wide. Already at room temperature and even more at temperatures above room temperature, this results in a considerable play. In combination with generally unavoidable small asymmetries this may cause undesired effects such as, vibrations, oscillations, hunting and noise.

To prevent such effects, a mechanical radial biasing between motor shaft and shaft bearing may be foreseen, for example by way of a biasing spring element. Such biasing, however, generally requires further components and further increases the frictional losses and wear.

In view of this situation it is an overall objective of the present invention to improve the design of brushless DC motors. Favorable, some or more of the before-mentioned problems are avoided fully or in part.

In a general way, the overall objective is achieved by the subject of the independent claims. Exemplary embodiments are further defined by the dependent claims as well as the description and the figures.

A type of brushless DC motor in accordance with the present invention includes a stator, a rotor, a motor shaft and a shaft bearing. The brushless DC motor further has a motor axis. The motor axis corresponds to respectively is the rotational axis of the rotor with respect to the stator and is generally an axis, in particular a symmetry axis, of the motor shaft. The stator includes a set of teeth that are in each case spaced from the rotor by a gap having a gap width. To this extent, the brushless DC motor may be designed as generally known in the art. The permanent magnet rotor, generally referred to as rotor in the following rotor, may include a circumferential rotor magnet, which is typically realized as a permanent magnet. Alternatively, the rotor may include a number of circumferentially distributed rotor magnet elements that form, in combination, the rotor magnet. The rotor magnet has a number or rotor poles as generally known in the art. A radial magnetic field is present between each of the teeth and the rotor, respectively the rotor magnet. A magnetic field that results from the superimposition of the individual magnetic fields is referred to as resulting radial magnetic field or resulting magnetic field.

In some embodiments that are generally assumed in the following, the stator, the motor shaft and the shaft bearing are arranged in coaxial arrangement around the motor axis. In an alternative design as discussed further below, the stator and the rotor are eccentric respectively non-coaxial with respect to each other.

In accordance with the present disclosure, the motor shaft and the shaft bearing are radially biased with respect to each other by a magnetic biasing force. The magnetic biasing force acts in a fixed radial direction. For the here-discussed type of brushless DC motor, the tooth design may differ among the teeth. With other words, the tooth design is not identical for all teeth. It so noted, however, that not all teeth need to differ in design from all other teeth, but at least two different tooth designs are present. As will be discussed in more detail in the following, the difference in design among the teeth does typically, but not necessarily, refers to a different tooth tip design. Due the tooth design differing among the teeth, a magnetic biasing force is generated.

The magnetic biasing force acting in a fixed radial direction means that the magnetic biasing force is radially directed and that this direction does not substantially change as the rotor rotates, i.e. the direction is design-given and fixed with respect to a non-moving and in particular non-rotating coordinate system. The absolute value of the magnetic biasing force is typically constant or at least substantially constant. The magnetic biasing force is independent from a powering of the brushless DC motor and is in particular present in a non-powered state.

The magnetic biasing force as explained before is preferably designed to ensure radial contact between the motor shaft on the one side and the shaft bearing on the other side. Thereby, any undesired radial movement is prevented, even under presence of play between shaft and shaft bearing. To this extent, the magnetic biasing force has the same effect as a mechanical, e.g. spring-based biasing between motor shaft and shaft bearing, while avoiding, however, the drawbacks that are associated with a direct mechanical contact. It has been surprisingly found that such magnetic biasing force can be applied without substantially affecting the driving torque that is generated by the brushless DC motor.

The magnetic biasing force may generally be chosen in dependence with the overall design and the application. In a typical servo drive application, it may, e.g., be in a range of 100 mN to 200 mN. Favorably, the magnetic biasing force is larger than further (generally undesired) radial forces, resulting, e.g. from an unbalance of the rotor. Further, the magnetic biasing force may be chosen to be larger than the gravitational force of the rotor, in order to ensure that the desired biasing is always present also e.g. for a horizontal orientation of the motor axis and in any mounting position.

As generally known in the art, the teeth are circumferentially distributed. In typical embodiments, the teeth are equally distributed with an identical angle between each two adjacent teeth. In another embodiment the teeth are divided in similar groups of two or more teeth, the different groups being evenly distributed over the circumference. The number of teeth depends on the number of phases of the drive current as well as the general motor design. In a typical design as used, e.g., in a servo drive, the motor may have 3 phases and 3 teeth per phase, i.e. 9 teeth in total. Other arrangements, however, may be used as well.

The brushless DC motor generally further includes a number of stator windings respectively stator coils as generally known in the art. In a typical design, a respective stator winding is carried by each of the teeth respectively arranged around each of the teeth. Other designs, however, are possible as well.

Typically, the gap between the teeth and the rotor is an air gap. In some applications, the motor may be used in a non-air-environment, e.g. in a compartment filled with inert gas, or the motor may as such be encapsulated and filled with a gas different from air, e.g. an inert gas. In such cases a gas different from air may be present in the gap. In a typical design, the gap width is, for example, 0.5 mm.

In an embodiment, the rotor and the stator are axially biased by a further magnetic biasing force, the further magnetic biasing force acting in axial direction. Such further magnetic biasing force may be obtained by an axial offset between the teeth and the rotor respectively the rotor magnet. An axial offset means that centers of the teeth and the center of the rotor magnet respectively rotor poles are axially displaced with respect to each other. The teeth respectively their tooth tips as discussed further below and the rotor magnet may, however, axially overlap.

In an embodiment, a resulting magnetic field between the stator and the rotor is non-zero, the resulting magnetic field being a superimposition of the radial magnetic fields between the individual teeth and the rotor. The resulting magnetic field is a radial field and is independent from a powering of the brushless DC motor. It is in particular given also in the non-powered state. To put it differently, the individual radial magnetic fields between the individual teeth and the rotor magnet are not designed to cancel each other out, with the remaining radial force serving as radial biasing force.

In an embodiment, the gap width is not identical for all teeth. By varying the gap width among the teeth, the strength of the magnetic field is also varied, since the magnetic field decreases with increasing gap width. Thereby, a resulting non-zero radial magnetic field can be achieved.

As used in this document, the expression “gap width” refers to an effective radial distance between a tooth, for example a tooth tip respectively its front surface, and the rotor, in particular the rotor magnet. Within one and the same tooth, the actual distance may and typically does vary radially and/or axially. The expression “gap width” accordingly refers to a nominal gap width as determined by the design and typically with the rotor and the stator being axially aligned with respect to the motor axis. For each of the teeth, the gap width is a design-given and constant value.

In practice and during operation of the brushless DC motor, the gap continuously slightly varies for each tooth due to the play between motor shaft and shaft bearing and the radial biasing force. It is further noted that the teeth may in some embodiments be fully or partly coated by a non-conductive material which may also cover the tooth tip front surface that that faces the rotor respectively the rotor magnet. In such embodiment, the gap is partly filled with the coating rather than air respectively gas. Since it is non-magnetic, however, such coating does not influence the gap width.

In an embodiment, the set of teeth includes one or more first-type teeth and each tooth that is not a first-type tooth is a second-type tooth. The one or more first-type teeth differ in design from the second-type teeth. If more than one first-type teeth are present, the first-type teeth may be designed identically but may also vary in design as discussed further below. In a typical embodiment, the second-type teeth are generally designed identically or substantially identically. The difference in design between the first-type teeth and the second-type teeth may in particular relate to one or more the materials from which the teeth are made, the tooth dimensions, as well as the presence and/or design of tooth tips as discussed further below.

In an embodiment, a subset of circumferentially consecutive teeth are first-type teeth and all further teeth are second-type teeth.

The number of first-type teeth is in an embodiment chosen in accordance with the number of phases and stator poles of the brushless DC motor. By way of example, there may be three first-type teeth for a motor having three phases and twelve tooth tips in total. Other designs, for example a single first-type tooth, however. may be used as well.

In an embodiment, the teeth include in each case a respective tooth tip. The tooth tips may generally be designed as known in the art and are formed, in each case, by a peripheral region of a tooth. In some embodiments, however, the design and/or arrangement of the tooth tips is modified as discussed in more detail in the following. Tooth tips are also known as pole shoes.

In an embodiment, each first-type tooth includes a respective first-type tooth tip and each second-type tooth includes a respective second-type tooth tip. The first type tooth tip or first type tooth tips differ(s) in design from the second-type tooth tips. In particular, different gap widths between first-type teeth and second-type teeth as mentioned before may be achieved via differently designed respectively differently shaped tooth tip front surfaces for first-type respectively second-type tooth tips.

In an embodiment, all first-type tooth tips are of identical design or substantially identical and all second-type tooth tips are of identical design or substantially identical design. This, however, is not essential. In particular, the tooth tip design respectively a gap width may be different among the first-type tooth tips. By way of example, a central first-type tooth of a subset of first-type teeth as mentioned may have a central first-type tooth tip with a central tooth tip recess. Further outer first-type teeth may in each case have a respective outer first-type tooth tip with a respective outer tooth tip recess. The outer first-type teeth may be arranged on both sides of the central first-type tooth. The central tooth tip recess may for example be wider and/or deeper as compared to the outer tooth tip recesses. Thereby, the gap is wider for the central first-type tooth as compared to the outer first-type teeth. Another number of first-type teeth may be present as well. In an embodiment, the gap width may vary in a sinusoidal manner among the first-type tooth tips. Generally, the subset of first-type teeth may in the circumferential direction have a subset center and the tooth design, in particular the tooth tip design, may vary among the first-type teeth in an angularly symmetrical manner with respect to the subset center. The gap width may be largest for the subset center. The before-mentioned sinusoidal variation is an example for this type of design.

In an embodiment, each first-type tooth tip has a tooth tip recess that extends from a tooth tip front surface of the respective first-type tooth tip. The tooth tip recesses result in an increase of the gap width for each of the first-type teeth as compared to the second-type teeth. The second-type tooth tips of the second-type teeth may, in contrast, not have such a tooth tip recess or may have a differently designed or dimensioned, in particular smaller tooth tip recess. A cross section of the tooth tip recesses may, e.g., be circular or substantially rectangular.

In an embodiment, the tooth tip recess has in each case a main extension direction parallel to the motor axis. Parallel to the motor axis respectively in axial direction, the dimension of the tooth tip recesses is accordingly larger than in the circumferential direction. Such a tooth tip recess is also referred to as axial tooth tip recess. The axial extension is also referred to as length of a tooth tip recess.

In a further embodiment, the tooth tip recess may be realized as a bore or blind hole that extends from the tooth tip front surface of the respective first-type tooth tip. Such type of recess may be formed by an e.g. cylindrical blind holes or bores, with a recess axis, in particular a symmetry axis of the bore, extending e.g. radially towards and transverse to the rotor axis. Such design is favorable in that the recesses can be efficiently realized by way of drilling.

In an embodiment, the tooth tip recess extends in each case from the tooth tip front surface of the respective first-type tooth tip in a circumferentially centered manner. For such design, the first-type tooth tip extends in each case symmetrically to the respective tooth tip recess in top view respectively view along the motor axis.

In an embodiment, the tooth tip recess extends in each case over less than an axial extension of the respective first-type tooth tip. For a tooth tip recess that extends parallel to the motor axis as mentioned before, the tooth tip recess of a first-type tooth tip is typically but not necessarily arranged in an axially centered manner. By the axial extension of the recesses, the effective gap width and accordingly the magnetic biasing force may be adjusted as needed.

In an embodiment, the stator includes a stack of axially stacked stator sheets, the stator sheets being in each case made from sheet metal, in particular ferromagnetic metal, e.g. iron. Such design of the stator, also known as laminated stator, is generally known in the art. The number of stator sheets that forms the stack may be chosen in accordance with the overall design. A typical number is, e.g. 10. For a motor design in accordance with the present disclosure, some or all stator sheets may be modified as compared to a state-of-the art design in particular as explained in the following. The teeth and tooth tips are formed, in combination, by the stator sheets, with each stator sheet generally forming part of each tooth and tooth tip respectively.

In an embodiment with a laminated stator, the tooth tip recess extends for each first-type tooth tip in a number of inner stator sheets for the respective first-type tooth tip. The inner stator sheets are axially arranged between opposing outermost stator sheets, wherein the tooth tip recess does in each case not extend into the outermost stator sheets. As far as the outermost stator sheets are concerned, the design may be identical for first-type teeth respectively first-type tooth tips and second-type teeth respectively second-type tooth tips. That is, the design may accordingly be identical for all teeth and tooth tips, being it first-type or second-type teeth and tooth tips. The outermost stator sheets may accordingly be designed in each case as known in the art.

This type of design is particularly advantageous in that in the top view respectively view along the motor axis there is no difference between the first-type pole teeth and first-type tooth tips, on the one side, and the second-type teeth and second type tooth tips on the other side. The overall design of the stator is accordingly rotationally symmetric like in conventional designs, which is favorable, e.g. regarding, assembly, handling, and centering. In this way, the process of assembling the stator windings can be identical for teeth.

For forming a tooth tip recess, the inner stator sheets may each have an axially through-going stator sheet depression respectively stator sheet cutout for each first-type tooth tip, with the stator sheet depressions being circumferentially aligned with respect to each other and forming, in combination, an axial tooth tip recess that extends over the whole axial extension of a first-type tooth tip with exception of the outermost stator sheets. If desired, more than one outermost stator sheet at each axial side may not have a stator sheet depression. In this way, the length respectively axial extension of the tooth tip recesses may be reduced.

In a further embodiment, the inner stator sheets do typically not have stator sheet depression as explained before in order to form the tooth tip recesses. Instead, the tooth tip recess of a first-type tooth tip may be formed by some or all inner stator sheets having, a smaller radial extension as compared to the outermost stator sheets. For such a design, the tooth tip recess of a first-type tooth tip does in each case not extend over the whole axial extension of the respective first-type tooth tip, but extends over its whole circumferential extension. Such tooth tip recess is referred to as circumferential tooth tip recess. In a further variant, there is no difference between inner and outer stator sheets. Instead, all stator sheet may have a smaller radial extension for a first-type tooth tip as compared to a second-type tooth tip.

In a further embodiment with one or more first-type teeth and with second-type teeth, the first-type teeth do in each case not include a tooth tip, while the second-type teeth do in each case include a respective tooth tip. Also this measure results in a non-zero resulting radial magnetic field between the stator and the rotor.

In a further embodiment with one or more first-type teeth and second type teeth, the one or more first-type teeth is/are made, at least in part, from a first type of material while the second-type teeth are in case made, at least in part, form a second type of material, wherein the first type of material is different from the second type of material. The first type of material and the second type of material may in particular have different ferromagnetic properties, in particular different magnetic permeability. Also this measure results in an inhomogeneity of the magnetic field between the teeth and the stator over the circumference of the stator.

In another type of brushless DC motor in accordance with the present invention, the brushless DC motor includes a stator, a rotor, a motor shaft and a shaft bearing. The brushless DC motor further has a motor axis. The motor axis corresponds to respectively is the rotational axis of the rotor with respect to the stator and is generally an axis, in particular a symmetry axis, of the motor shaft. The stator includes a set of teeth that are in each case spaced from the rotor by a gap having a gap width. Alternatively, the rotor may include a number of circumferentially distributed rotor magnet elements that form, in combination the rotor magnet. The rotor magnet has a number or rotor poles as generally known in the art. The motor shaft and the shaft bearing are radially biased with respect to each other by a magnetic biasing force the magnetic biasing force acting in a fixed radial direction. The brushless DC motor of this type includes a biasing magnet. The biasing magnet is fixed with respect to the stator.

This type of brushless DC motor is generally similar to the before-described type. The magnetic biasing force, however, is generated by the biasing magnet rather than via differently designed tooth. It is noted that the reference to an embodiment of a brushless DC motor may generally equally refer to either type.

The biasing magnet may, for example be realized as a radially arranged permanent magnet. The biasing magnet may for example be arranged between two in circumferential direction neighboring teeth.

It is noted the measures for providing the magnetic biasing force may also be combined. That is, differently designed teeth with one or more first-type teeth and second type teeth as well as a biasing magnet may be present. In such design, the tooth design as discussed above as well as the biasing magnet each contribute to the magnetic biasing force.

In an embodiment, the shaft bearing is made from plastics. While being favorable regarding costs, tolerances are generally wider for a shaft bearing made from plastics as compared, e. g. from a ball bearing or a sintered bearing. Further, typically used plastics have a relatively large thermal expansion coefficient. Therefore, the before-mentioned problems and drawbacks that result from significant tolerances between motor shaft and shaft bearing are particularly critical if the shaft bearing is made from plastics. In a typical design, a nominal play between motor shaft and shaft bearing may be in the range of some few hundredths of a millimeter, e.g. 3/100 mm at room temperature, which is significantly more as compared, e.g., to known designs with sintered bearing.

In an embodiment, the rotor is an external rotor. For this type of design, the brushless DC motor is an outrunner, with the stator being arranged radially inside with respect to the rotor respectively the rotor circumferentially surrounding the stator. The rotor may be designed as generally known in the art. In particular, the rotor may be bell-respectively cup-shaped. In a particular design, the external rotor carries the shaft bearing in its center, while the motor shaft is arranged in the center of the stator and fixed thereto. In alternative embodiments, however, the external rotor may include the motor shaft and the shaft bearing may be arranged in the center of the stator and fixed thereto. In a particular design, the external rotor carries or includes a pinion as output element. In particular designs, a toothed wheel, in particular a pinion and/or the shaft bearing may form an integrated part of the rotor. In particular, the shaft bearing may be made from plastics. In an embodiment, the rotor is general made from plastics, especially injection-molded plastics, and the rotor magnet or a number of circumferentially distributed magnet elements are embedded into the rotor as insert parts.

In a further embodiment, the rotor is an internal rotor. For this type of design, the brushless DC motor is an inrunner, with the stator being arranged radially outside with respect to the rotor respectively the stator circumferentially surrounding the rotor.

In an embodiment, the brushless DC motor is designed for operation in a temperature range having a lowest temperature of at least −10 degrees Celsius, in particular −20 degrees Celsius or −30 degrees Celsius, and a highest temperature of at least 50 degrees Celsius, in particular 60 degrees Celsius, 70 degrees Celsius, 130 degrees Celsius or 150 degrees Celsius. Such temperature range is typical, e. g. in HVAC applications and is demanding in particular regarding tolerances and thermal expansion.

According to a further aspect, the overall objective is achieved by a servo drive, in particular a servo drive for controlling a valve or a damper. The servo drive includes a brushless DC motor according to any embodiment as discussed above and/or further below. The servo drive further includes a reduction gear in operative coupling with the brushless DC motor.

### BRIEF DESCRIPTION OF THE DRAWINGS

The herein described invention will be more fully understood from the detailed description given herein below and the accompanying drawings which should not be considered limiting to the invention described in the appended claims. The drawings show:

FIG. 1 An embodiment of a brushless DC motor with external rotor according to the present invention in a schematic sectional view;

FIG. 2 An embodiment of a brushless DC motor with internal rotor according to the present invention in a schematic sectional view;

FIG. 3 Elements of an embodiment of a brushless DC motor according to the invention in a schematic top view;

FIG. 4 Elements of a further embodiment of a brushless DC motor according to the invention in a schematic top view;

FIG. 5 A first-type tooth tip of a further embodiment of a brushless DC motor according to the present invention in a schematic longitudinal sectional view;

FIG. 6 A first-type tooth tip of a further embodiment of a brushless DC motor according to the present invention in a schematic longitudinal sectional view;

FIG. 7 A view on a tooth-tip front surface of a first-type tooth tip of a further embodiment of a brushless DC motor according to the present invention;

FIG. 8 Elements of a further embodiment of a brushless DC motor according to the invention in a schematic top view;

FIG. 9 Elements of a further embodiment of a brushless DC motor according to the invention in a schematic top view;

FIG. 10 Elements of a further embodiment of a brushless DC motor according to the invention in a schematic top view;

FIG. 11 Elements of a further embodiment of a brushless DC motor according to the invention in a schematic top view;

FIG. 12 A servo drive in accordance with the present disclosure in a schematic view.

### DESCRIPTION OF THE EMBODIMENTS

In the following, exemplary embodiments are described in more detail with additional reference to the figures. Whenever possible, like reference signs be used to refer to like or substantially like components or parts.

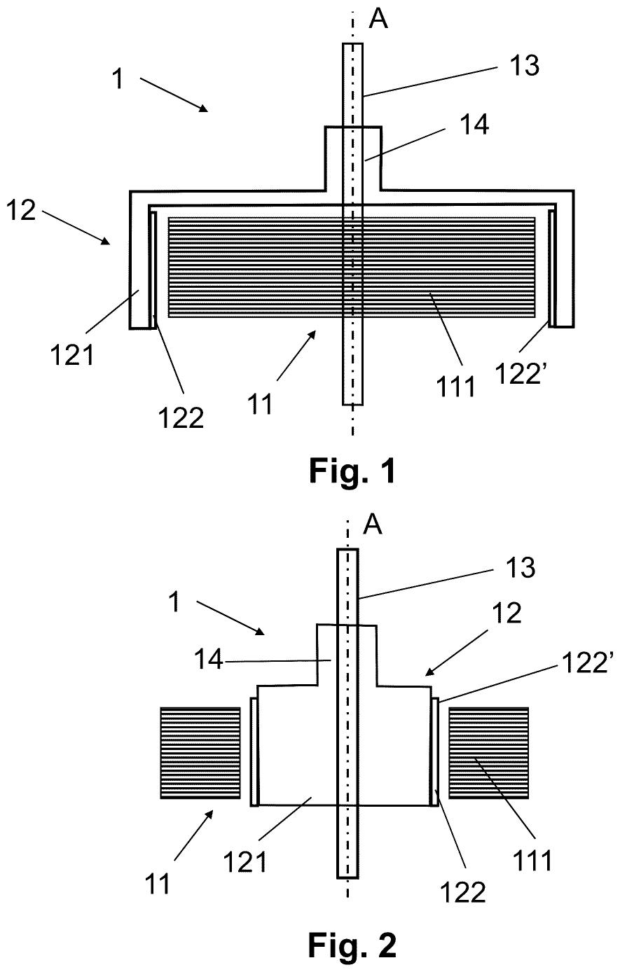

FIG. 1 and FIG. 2 show two exemplary embodiments of a brushless DC motor 1 in accordance with the present disclosure in a schematic sectional view, with the sectional plane comprising the motor axis A. It is noted that in the view of FIG. 1 and FIG. 2, the brushless DC motor 1 does not differ from generally known designs according to the state of the art.

The embodiment pursuant to FIG. 1 differs from the embodiment of FIG. 2 in that the brushless DC motor in the embodiment of FIG. 1 has an external rotor while it has an internal rotor in the embodiment of FIG. 2. Where not stated differently, the design of the brushless DC is generally according to the state of the art.

The brushless DC motor 1 has a stator 11, a rotor 12, a motor shaft 13 and a shaft bearing 14, in particular a sintered bearing or plastic bearing in coaxial arrangement as generally known in the art. In the shown design, the motor shaft 13 is fixed with respect to the stator 12 and does not rotate as the brushless DC motor runs. Instead, the rotor 12 rotates with around the motor shaft 13 and the stator 11, with the shaft bearing 14 being arranged at the interface of rotor 12 and motor shaft 13. An output element such as a toothed wheel (not explicitly shown), may be mounted on or formed integrally with the rotor 12 in such design. Also, the shaft bearing may optionally be formed integrally with the rotor 12. In alternative designs, however, the motor axis 13 may be fixed with respect to the rotor 12 and rotate therewith. In such design, the output element such as a toothed wheel may be mounted to or be formed integrally with the motor axis 13 and the shaft bearing 14 may be fixed in a motor housing or support structure (not explicitly shown).

The stator 11 comprises a core 111 which may in particular be a laminated core. The stator 11 and in particular the core 111 may be in principle designed as known in the art, but modified in accordance with the present disclosure as discussed further below.

The rotor 12 may be designed as known in the art. It comprises a rotor body 121 which is generally cup- or bell-shaped in case of an external rotor and as substantially compact body in case in an inner rotor. The body 121 is generally made from ferromagnetic material. A ring-shaped circumferentially magnetized rotor magnet 122 is in the shown figure arranged at the circumferential inner periphery of the rotor body 121 in case of an external rotor and at the circumferential outer periphery of the rotor body 121 in case of an internal rotor. While other designs may be used as well, the rotor magnet 122 may have 12 poles with a sinusoidal or rectangular magnetization. In alternative designs the rotor magnet may not be realized as circumferentially continuous ring, but by a number of circumferentially distributed rotor magnet elements.

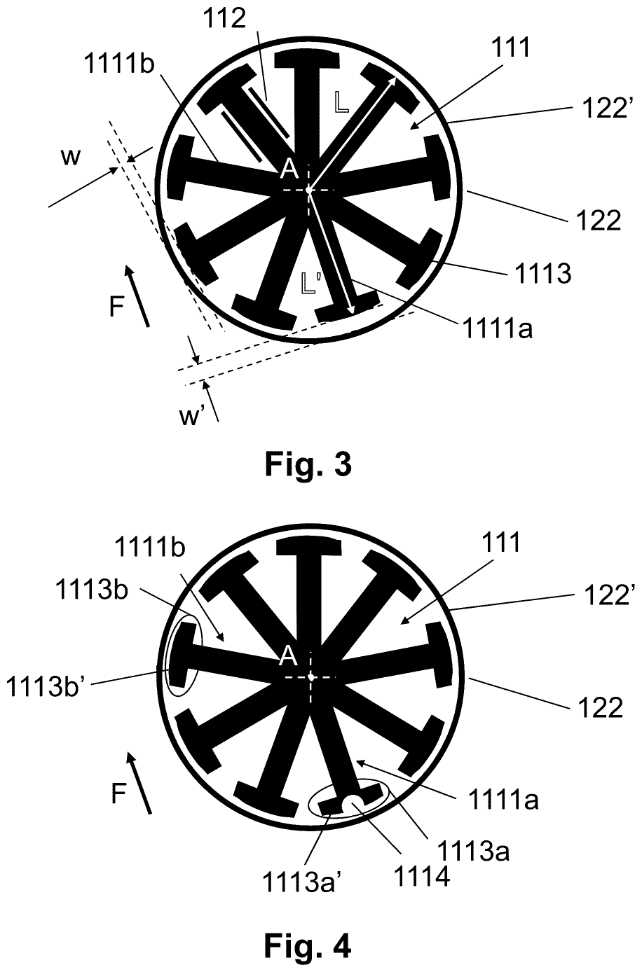

FIG. 3 shows a top view (along the motor axis A) of an embodiment of the external rotor brushless DC motor pursuant to FIG. 1 in a schematic top view, with the rotor body 121 being omitted for clarity reasons. The laminated core 111 comprises a number of teeth 1111a, 1111b that are arranged around the motor axis A in a generally concentric and-star-like manner, with each tooth corresponding to a respective stator pole and carrying a respective stator winding 112 (only shown for one tooth) in this design. Other stator winding arrangements, however, are possible as well. In the shown design, exemplarily nine teeth are present. At its end, each tooth widens into a respective tooth tip 1113 as generally known in the art. All teeth 1111a, 1111b and tooth tips 1113 are formed in an integral manner, in combination forming the laminated core 111. To this extent, the design shown corresponds to the state of the art for a brushless DC motor with 9 stator poles and 3 phases.

In contrast to the state of the art, however, exemplarily one of the teeth is a first-type tooth 1111a which is designed differently from the other eight teeth which are second-type teeth 1111b as follows: While the principle design and the design of the tooth tip 1113 is identical to the state of the art, the first-type tooth tip 1111a has a smaller tooth length L′ as compared to the tooth length L of the second-type teeth 1111b. The gap width w′ between the first-type tooth 1111a respectively its tooth tip 1113 and the rotor magnet 122 (with the individual rotor poles not being explicitly shown) respectively its circumferential (inner) surface 122′ is accordingly larger than the gap width w between each of the second-type teeth 1111b respectively their respective tooth tips 1113 and the rotor magnet 122, respectively its circumferential (inner) surface 122′. Thereby, the (radial) magnetic field between the first-type tooth 1111a and the rotor magnet 122 is weaker as compared to the (radial) magnetic field between each of the second-type teeth 1111b and the rotor magnet 122. The larger gap width w′ results in a radial magnetic biasing force F as indicated. It is noted that the shown arrow only indicated the direction of the magnetic biasing force for illustrative reasons, while the point of force application is at the center of the rotor 12 respectively the motor axis A.

FIG. 4 illustrates a further embodiment of a brushless DC motor 1 in accordance with the present disclosure in a view corresponding to FIG. 3. Since the embodiment of FIG. 4 corresponds in various aspects to the embodiment of FIG. 3, the following description is focused on the differences. The sectional view along the motor axis A is, like in the-before-discussed embodiment, given by FIG. 1.

In the embodiment of FIG. 4, the tooth length is in principle identical for the first-type tooth 1111a and the second-type teeth 1111b. The first-type tooth 1111a, however has a first-type tooth tip 1113a that is designed differently as compared to the second-type tooth tips 1113b of the second-type teeth 1113b. In contrast to the second-type tooth tips 1113b that are designed as known in the art, the first-type tooth tip 1113a comprises a tooth tip recess 1114 that extends from the tooth tip front surface 1113a′ of the first-type tooth tip 1113a. The tooth tip recess 1114 extends in this design parallel to the motor axis A. By way of the tooth tip recess 1114, the gap width is effectively increased and the magnetic field is locally weakened for the first-type tooth 1111a, even though the actual distance that is measurable between the tooth tip front surface 1113a′ and the circumferential inner surface 122′ of the rotor magnet 122′ is identical to the second-type-tooth tips 1113b over the entire surface of the tooth tips with exception of the tooth tip recces 1114. The tooth tip front surface 1113b′ of each of the second-type pole tooth tips, 1113b, in contrast, is not recessed.

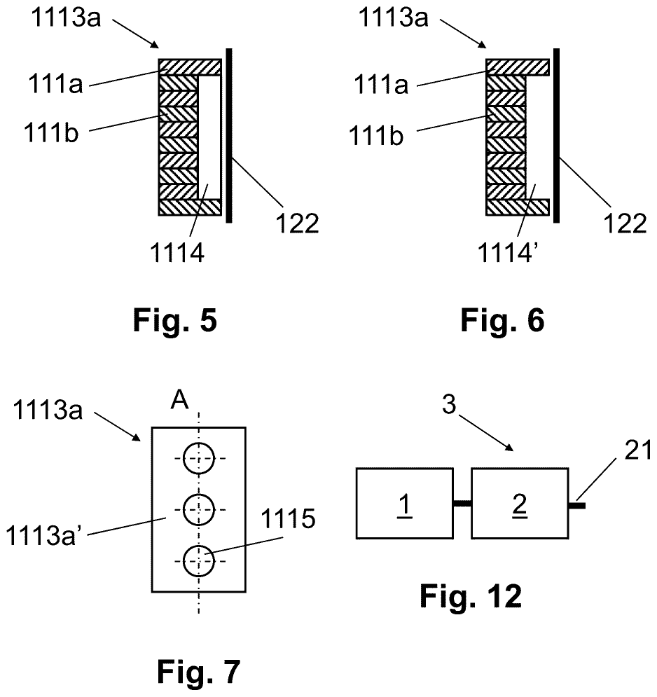

FIG. 5 schematically shows a longitudinal sectional view through the first-type tooth tip 1113a, together, with the rotor magnet 122 for a further embodiment of a brushless DC motor 1 in accordance with the present disclosure as discussed in the following.

It is noted that in all embodiments, including the embodiments as illustrated before as well as further below, the stator 11 is normally a laminated stator made of a stack of stator sheets as generally known in the art. In the embodiments as illustrated in FIG. 3 and FIG. 4, all stator sheets are of identical design. In the embodiment as illustrated in FIG. 4, the tooth tip recess 1114 is accordingly axially continuous respectively through-going, in contrast to the embodiment as illustrated in FIG. 5. As this embodiment corresponds in most aspects to the embodiment of FIG. 4, the following description is focused on the differences.

The stator 11 is made from exemplarily ten stator sheets. The two outermost stator sheets, 111a are in this embodiment non-recessed and accordingly correspond to FIG. 3 for all teeth 1111a, 1111b and respective tooth tips 1113a, 11113b. The inner stator sheets 111b, i.e., all stator sheets between the outermost sheets 111a, in contrast, are recessed for the first-type tooth tip 1113a and have a top view that corresponds to the first-type tooth tip 1113a in FIG. 4.

For this design, the tooth tip recess 1114 does accordingly not extend over the hole axial extension of the stator 1 respectively the first-type tooth tip 1113a, but only the inner stator sheets 111b. While the weakening effect on the magnetic field is somewhat lower, this design has the advantage that the overall outer contour is identical for all teeth respectively tooth tips, which is favorable with respect to assembly in general and in particular of the stator windings 112. In further similar designs, the arrangement of recessed and non-recessed stator sheets may be varied along the motor axis A and comprise a sequence of recessed and non-recessed stator sheets in generally any desired order. By way of example, every second stator sheet may be recessed respectively non-recessed. The outermost stator sheets are favorably in each case non-recessed.

FIG. 6 schematically shows a longitudinal sectional view through the first-type tooth tip 1113a, together, with the rotor magnet 122 for a further embodiment of a brushless DC motor 1 in accordance with the present disclosure, similar to FIG. 5.

Like in the embodiment of FIG. 5, the outermost stator sheets 111a are designed differently from the inner stator sheets 111b. In contrast to the embodiment as shown in FIG. 5, the tooth tip recess 1114′ does not extend parallel to the motor axis A, but transverse thereto, respectively circumferentially. This may be achieved by the tooth tip front surface being set back towards the motor axis A for the inner stator sheets 111a (generally corresponding to the first-type tooth 1111a as illustrated in FIG. 3) as compared to the outermost stator sheets 111a (generally corresponding to the second-type teeth 1111b as illustrated in FIG. 3).

FIG. 7 schematically shows the view on a tooth tip front surface 1113a′ of a first-type tooth tip 1113a for a further embodiment of a brushless DC motor 1 in accordance with the present disclosure. For this type of embodiment, a number of blind holes 1115 extends from the other-wise smooth tooth tip front surface 1113a′ of the first-type pole shoe 1113a into the first-type tooth tip 1113a. By this measure, the effective gap width is also increased and the magnetic field is accordingly weakened, similar to the before-described embodiments. It is noted that the arrangement of three blind holes 1115 that are distributed along the motor axis A is merely exemplary. Other arrangements with more or less blind holes as well as other arrangements of the blind holes are possible as well.

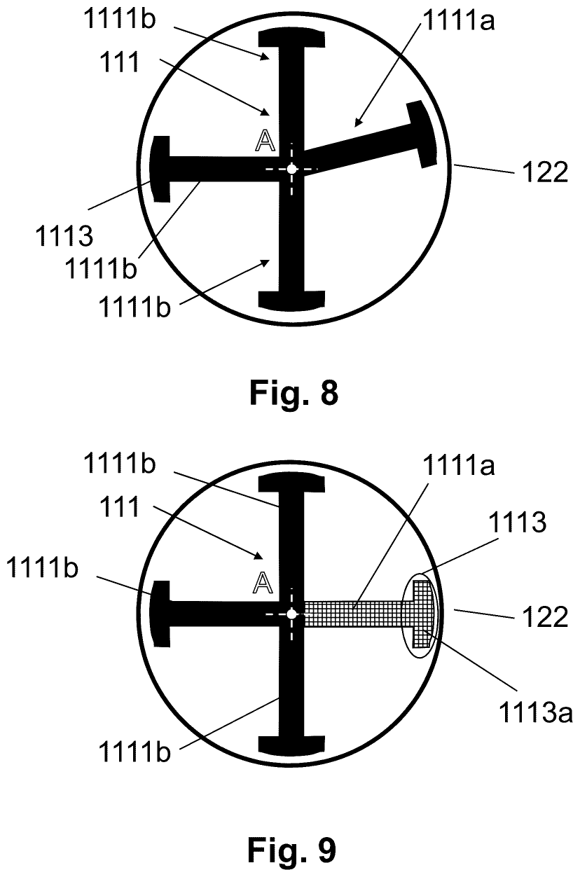

FIG. 8 schematically shows the core 111 together with the rotor magnet 122 of a further embodiment of a brushless DC motor 1 in accordance with the present disclosure in a schematic top view. The brushless DC motor 1 has two phases and four poles in this example. All of the poles have identically designed teeth and tooth tips. In a state-of-the-art design for such a motor, the angle between each two circumferentially consecutive respectively neighboring teeth is 90 degrees. In the design as shown in FIG. 8, one of the teeth, namely fist-type tooth 1111 a, is arranged in a different angle to its neighboring second-type pole teeth 1111b, respectively in an asymmetric manner. As a consequence, the overall resulting radial magnetic field is also distorted as compared to a symmetric radial field and non-zero, and a radial magnetic biasing force is accordingly created.

FIG. 9 schematically shows the core 111 together with the rotor magnet 122 of a further embodiment of a brushless DC motor 1 in accordance with the present disclosure in a schematic top view. In the embodiment of FIG. 9, the core 111 comprises four teeth with an angle of 90 degrees between neighboring poles as in in a state-of-the-art design. In the design of FIG. 9, however, one of the teeth and the respective tooth tip, namely first-type tooth 1111a′ is made from a different material as compared the other second-type teeth 1111b. In particular, the first-type tooth 1111a may be made from a non-magnetic material, while the core 111, in particular the second-type teeth 1111b with its teeth is made from ferromagnetic material according to the state of the art. As a consequence, the overall resulting radial magnetic field is also distorted as compared to a symmetric radial field and non-zero, and a radial magnetic biasing force is accordingly created. It is noted that the design and geometry may be identical for the first-type tooth 1111a and the second-type teeth 1111b. Further, a combination of different tooth geometries and/or materials are possible.

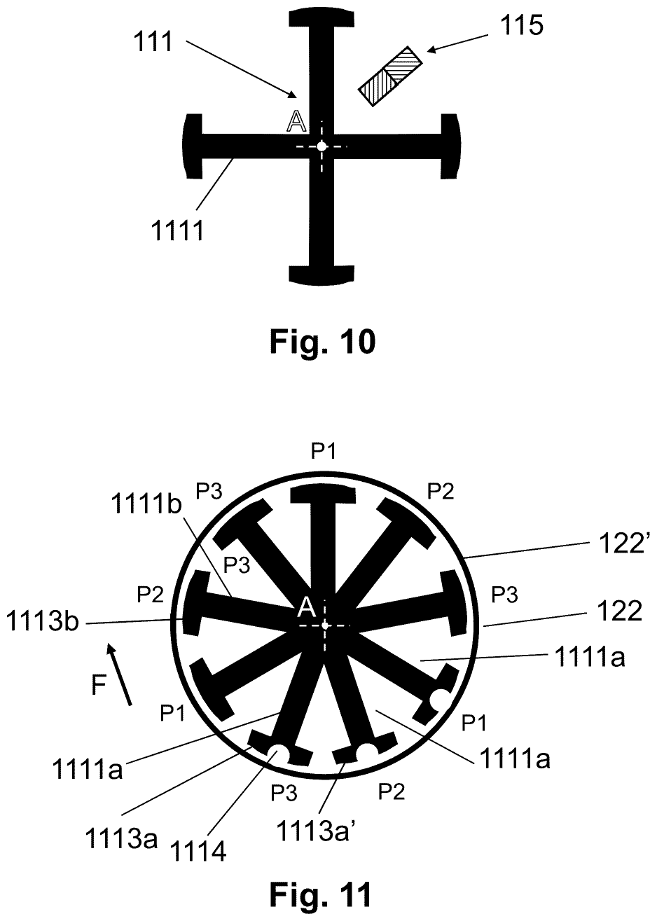

FIG. 10 schematically illustrates a further way to generate a magnetic biasing force in a brushless DC motor 1 in accordance with the present disclosure. Here, the core 111 is designed according to the state of the art with exemplarily four identical teeth 1111 in symmetric arrangement. To provide a magnetic biasing force, a dedicated biasing magnet 115 with radial orientation is arranged circumferentially between two neighboring teeth 1111. The biasing magnet 115 generates a further magnetic field that superimposes the otherwise radially symmetric or radially biased magnetic field, thereby creating a radial biasing force.

While the exemplary embodiments are mainly focused on a motor having an external rotor it is to be understood that a corresponding embodiment a motor having an internal rotor in a straight forward manner.

FIG. 11 shows a top view (along the motor axis A) of a further embodiment of the external rotor brushless DC motor pursuant to FIG. 1 in a schematic top view, similar to e.g. FIG. 3 and FIG. 4 as discussed above. The overall design is similar to the embodiment as discussed above with reference to FIG. 3. The following description is therefore focused on the differences.

Like in the embodiment of FIG. 3, the brushless DC motor 1 according to FIG. 11 has 9 poles and 3 phases, with the phases (referenced by P1, P2, P3) being arranged in circumferentially alternating manner as generally known in the art. In the design of FIG. 11, three circumferentially consecutive teeth are first-type teeth 1111a and have in each case a first-type tooth tip 1113a with a respective tooth tip recess 1114, with one of the first-type teeth 1111a being associated with each of the three phases P1, P2, P3. In this example the three first-type teeth 1111a form, in combination, a subset of first-type teeth. All other teeth are second-type teeth 1111b and have in each case a respective non-recessed second-type tooth tip 1113b. The in this example six second-type teeth 1111b form, in combination a subset of second-type teeth. By providing a first-type tooth 1111a per phase, otherwise present torque ripples are avoided.

FIG. 12 schematically shows a servo drive 3 in accordance with the present disclosure. The servo drive 3 includes a brushless DC motor 1 as discussed. The brushless DC motor 1 is operatively coupled to a reduction gear 2. A load, such as a valve or damper (not shown) may be coupled to an output element, in particular an output shaft, 21.

Rather, the words used in the specification are words of description rather than limitation, and it is understood that various changes may be made without departing from the Spirit and scope of the invention.

### REFERENCE SIGNS

1 brushless DC motor
11 stator
111 core
111a outermost stator sheet
111b inner stator sheet
1111 tooth
1111a, 1111a′ first-type tooth
1111b second-type tooth
1113 pole shoe
1113a first-type pole shoe
1113a′ pole shoe front surface (first-type pole shoe)
1113b second-type pole shoe
1113b pole shoe front surface (second-type pole shoe)
1114, 1114′ pole shoe recess
1115 blind hole
112 stator winding
115 biasing magnet
12 rotor
121 rotor body
122 rotor magnet
122′ circumferential inner surface or rotor magnet
13 motor shaft
14 shaft bearing
15 biasing magnet
21 output element
3 servo drive
A motor axis
F magnetic biasing force
L tooth length (second-type tooth)
L′ tooth length (first-type tooth)
P1, P2, P3 phase
W gap width (second-type tooth)
w′ gap width (first-type tooth)

1-16. (canceled)

17. A brushless DC motor comprising:
a stator;
a permanent magnet rotor;
a motor shaft; and
a shaft bearing,
wherein the brushless DC motor has a motor axis,
wherein the stator includes a plurality of teeth, each of the teeth being spaced apart from the rotor by a gap having a gap width,
wherein the motor shaft and the shaft bearing are radially biased with respect to each other by a magnetic biasing force, the magnetic biasing force acting in a fixed radial direction, wherein a tooth design of the teeth differs among the teeth.

18. The DC motor according to claim 17, wherein the plurality of teeth includes one or more first-type teeth, and
wherein each tooth that is not a first-type tooth is a second-type tooth, the one or more first-type teeth differing in design from the second-type teeth.

19. The DC motor according to claim 18, wherein a subset of circumferentially consecutive teeth are first-type teeth and wherein all remaining teeth are second-type teeth.

20. The brushless DC motor according to claim 18, wherein each first-type tooth includes a respective first-type tooth tip and each second-type tooth includes a respective second-type tooth tip.

21. The brushless DC motor according to claim 20, wherein each first-type tooth tip has a tooth tip recess that extends from a tooth tip front surface of the respective first-type tooth tip.

22. The brushless DC motor according to claim 21, wherein each tooth tip recess has a main extension direction parallel to the motor axis.

23. The brushless DC motor according to claim 21, wherein each tooth tip recess extends from the tooth tip front surface of the respective first-type tooth tip in a circumferentially centered manner.

24. The brushless DC motor according to claim 21, wherein each tooth tip recess extends over less than an axial extension of the respective first-type tooth tip.

25. The brushless DC motor according to claims 17, wherein the stator includes a stack of axially stacked stator sheets, each of the stator sheets being made from sheet metal.

26. The brushless DC motor according to claim 5, wherein the stator includes a stack of axially stacked stator sheets, each of the stator sheets being made from sheet metal, and
wherein the stack of axially stacked stator sheets includes inner sheets that are axially arranged between opposing outermost stator sheets,
wherein the tooth tip recess extends for each first-type tooth tip in a number of the inner stator sheets but does not extend into the outermost stator sheets.

27. The brushless DC motor according to claim 17, wherein a resulting magnetic field between the stator and the rotor is non-zero, the resulting magnetic field being a superimposition of the radial magnetic fields between the individual teeth and the rotor.

28. The brushless DC motor according to claim 17, wherein the shaft bearing is made from plastics.

29. The brushless DC motor according to claim 17, wherein the rotor is an external rotor.

30. The brushless DC motor according to claim 17, wherein the brushless DC motor is configured to operate in a temperature range having a lowest temperature of at least −10 degrees Celsius and a highest temperature of at least 50 degrees Celsius.

31. A brushless DC motor comprising:
a stator;
a permanent magnet rotor;
a motor shaft; and
a shaft bearing,
wherein the brushless DC motor has a motor axis,
wherein the stator includes a plurality of teeth, each tooth of the plurality of teeth being spaced apart from the rotor by a gap having a gap width,
wherein the motor shaft and the shaft bearing are radially biased with respect to each other by a magnetic biasing force, the magnetic biasing force acting in a fixed radial direction, and
wherein the brushless DC motor includes a biasing magnet, the biasing magnet being fixed with respect to the stator.

32. The brushless DC motor according to claim 31, wherein a resulting magnetic field between the stator and the rotor is non-zero, the resulting magnetic field being a superimposition of the radial magnetic fields between the individual teeth and the rotor.

33. The brushless DC motor according to claim 31, wherein the shaft bearing is made from plastics.

34. The brushless DC motor according to claim 31, wherein the rotor is an external rotor.

35. The brushless DC motor according to claim 31, wherein the brushless DC motor is configured to operate in a temperature range having a lowest temperature of at least −10 degrees Celsius and a highest temperature of at least 50 degrees Celsius.

36. A servo drive for controlling a valve or a damper, the servo drive comprising:
the brushless DC motor according to claim 17; and
a reduction gear coupled to the brushless DC motor.
